(19) United States
(12) Patent Application Publication
(10) Pub. No.: US 2022/0366854 A1
(43) Pub. Date: Nov. 17, 2022

(54) PIXEL ARRAY, ARRAY SUBSTRATE AND DISPLAY DEVICE

(71) Applicants: Beijing BOE Optoelectronics Technology Co., Ltd., Beijing (CN); BOE TECHNOLOGY GROUP CO., LTD., Beijing (CN)

(72) Inventors: Jiyang SHAO, Beijing (CN); Ziqiang GUO, Beijing (CN); Yuxin BI, Beijing (CN); Yadong DING, Beijing (CN); Feng ZI, Beijing (CN)

(21) Appl. No.: 17/286,072

(22) PCT Filed: Aug. 5, 2020
(86) PCT No.: PCT/CN2020/106982

§ 371 Date: Apr. 16, 2021

(30) Foreign Application Priority Data
Aug. 6, 2019 (CN) 201910723132.X

(51) Int. Cl. G09G 3/3266; G09G 3/3258

(52) U.S. Cl. CPC G09G 3/3266; G09G 3/3258; G09G 2300/0426; G09G 2310/08; G09G 2300/0842; G09G 2300/0452

(57) ABSTRACT

The present disclosure provides a pixel array, an array substrate and a display device, belongs to the field of display technology, and can solve the problem of low refresh rate in prior art. The pixel array of the present disclosure includes a plurality of rows of pixel units; each row of pixel units are controlled by a plurality of scan lines, and each pixel unit is supplied with a data voltage by a data line; and each pixel unit includes a plurality of switch transistors and a display module; and the plurality of switch transistors have first electrodes all coupled to the data line, second electrodes all coupled to the display module, and control electrodes coupled in one-to-one correspondence to the plurality of scan lines controlling the row of pixel units to which the pixel unit belongs.

### CROSS-REFERENCE TO RELATED APPLICATION

The present disclosure claims priority to Chinese Patent Application No. 201910723132.X filed on Aug. 6, 2019, the entire contents of which are incorporated herein by reference.

### TECHNICAL FIELD

The present disclosure belongs to the field of display technology, and particularly relates to a pixel array, an array substrate and a display device.

### BACKGROUND

With the continuous development of display technology, refresh rates of display panels are required to be higher and higher. At present, conventional display methods mainly adopt progressive scanning, and have a limited refresh rate of typically 60 Hz or 90 Hz.

In some application scenarios, such as rotating stereoscopic display, virtual reality (VR) and augmented reality (AR), an ultra-high refresh rate is required, but the conventional display methods and display panels cannot meet the requirement of high refresh rate.

### SUMMARY

In one aspect, the embodiments of the present disclosure provide a pixel array, including a plurality of rows of pixel units;

each row of pixel units are controlled by a plurality of scan lines, and each pixel unit is supplied with a data voltage by a data line; and

each pixel unit includes a plurality of switch transistors and a display module; and the plurality of switch transistors have first electrodes all coupled to the data line, second electrodes all coupled to the display module, and control electrodes coupled in one-to-one correspondence to a plurality of scan lines, which control the row of pixel units to which the pixel unit belongs.

In the embodiments, the pixel array further includes at least one gate drive circuit, and each gate drive circuit controls at least one row of pixel units; and

signal output terminals of each gate drive circuit are coupled in one-to-one correspondence to the plurality of scan lines, which are configured to control each row of pixel units controlled by the gate drive circuit.

In the embodiments, the number of the at least one gate drive circuit is plural, each gate drive circuit controls one row of pixel units, and different rows of pixel units are controlled by different gate drive circuits; and

signal output terminals of each gate drive circuit are coupled in one-to-one correspondence to the plurality of scan lines, which are configured to control one row of pixel units controlled by the gate drive circuit.

In the embodiments, among the pixel units in a same column, pixel units at an interval of N rows are supplied with data voltages by a same data line, with N being an integer greater than or equal to 1.

In the embodiments, the number of the at least one gate drive circuit is plural, and every I adjacent rows of pixel units are controlled by one gate drive circuit, with I being an integer greater than or equal to 2; and

signal output terminals of each gate drive circuit are coupled in one-to-one correspondence to the plurality of scan lines, which are configured to control each row of pixel units controlled by the gate drive circuit.

In the embodiments, among the pixel units in a same column, pixel units controlled by different gate drive circuits are supplied with data voltages by a same data line.

In the embodiments, different gate drive circuits operate at different time; and among the pixel units in the same column, pixel units at an interval of (I−1) rows are supplied with data voltages by a same data line.

In the embodiments, the number of the at least one gate drive circuit is 1, and the plurality of rows of pixel units is controlled by the one gate driver circuit, and

signal output terminals of the gate drive circuit are coupled in one-to-one correspondence to the plurality of scan lines, which are configured to control each row of pixel units.

In the embodiments, the pixel units are disposed in one-to-one correspondence with the data lines.

In the embodiments, the pixel array further includes a clock timing controller; and

the clock timing controller is coupled to the gate drive circuit and configured to provide a clock timing signal to the gate drive circuit.

In the embodiments, the pixel array further includes a data signal controller and a data timing controller;

the data signal controller is coupled to the pixel unit and configured to provide a data voltage to the pixel unit; and

the data timing controller is coupled to the data signal controller and configured to provide a data timing signal to the data signal controller.

In the embodiments, the display module includes a driving transistor, a storage capacitor and a light emitting device;

the driving transistor has a first electrode coupled to a first power supply terminal, a second electrode coupled to a second terminal of the storage capacitor and a first electrode of the light emitting device, and a control electrode coupled to a first terminal of the storage capacitor and a second electrode of each switch transistor;

the first terminal of the storage capacitor is coupled to the second electrode of each switch transistor and the control electrode of the driving transistor, and the second terminal of the storage capacitor is coupled to the second electrode of the driving transistor and the first electrode of the light emitting device; and

the first electrode of the light emitting device is coupled to the second electrode of the driving transistor and the second terminal of the storage capacitor, and the second electrode of the light emitting device is coupled to a second power supply terminal.

In the embodiments, the pixel unit includes a red sub-pixel unit, a green sub-pixel unit and a blue sub-pixel unit.

In another aspect, an embodiment of the present disclosure provides an array substrate, including the above pixel array.

In still another aspect, an embodiment of the present disclosure provides a display device, including the above array substrate.

### BRIEF DESCRIPTION OF THE DRAWINGS

FIG. 1 is a schematic structural diagram of a pixel array according to an embodiment of the present disclosure;

FIG. 2 is a schematic structural diagram of a pixel unit according to an embodiment of the present disclosure;

FIG. 3 is a schematic structural diagram of a pixel array according to an embodiment of the present disclosure;

FIG. 4 is a schematic structural diagram of another pixel array according to an embodiment of the present disclosure; and

FIG. 5 is a schematic structural diagram of still another pixel array according to an embodiment of the present disclosure.

### DETAILED DESCRIPTION

The present disclosure aims to solve at least one of the technical problems in the related art, and provides a pixel array, an array substrate and a display device.

The transistors used in the embodiments of the present disclosure may be thin film transistors, field effect transistors, or other devices having the same characteristics. Since the source and the drain of the used transistor is interchangeable under certain conditions, there is no difference between the source and the drain in terms of description of connection relationship. In the embodiments of the present application, in order to distinguish between the source and the drain of a transistor, one of the source and the drain is referred to as a first electrode, the other one is referred to as a second electrode, and the gate is referred to as a control electrode. In addition, the transistors can be divided into N-type transistors and P-type transistors according to the characteristics of the transistors, and both types of transistors can be used in the embodiments of the present disclosure. In the following description of the embodiments, description is given by taking a case where all switch transistors and driving transistors are N-type transistors as an example. For an N-type transistor, the first electrode is the source of the N-type transistor, the second electrode is the drain of the N-type transistor, and the source and the drain are electrically connected when a high level is input into the gate. The opposite is true for a P-type transistor. In order to enable those of ordinary skill in the art to better understand the technical solutions of the present disclosure, the pixel array, the array substrate and the display device provided by the present disclosure are further described in detail below with reference to the drawings and the specific embodiments. In the description below, as an example, pixel units adopt the most basic circuits of organic light-emitting diodes (OLEDs) and the thin film transistors in the pixel units are N-type transistors.

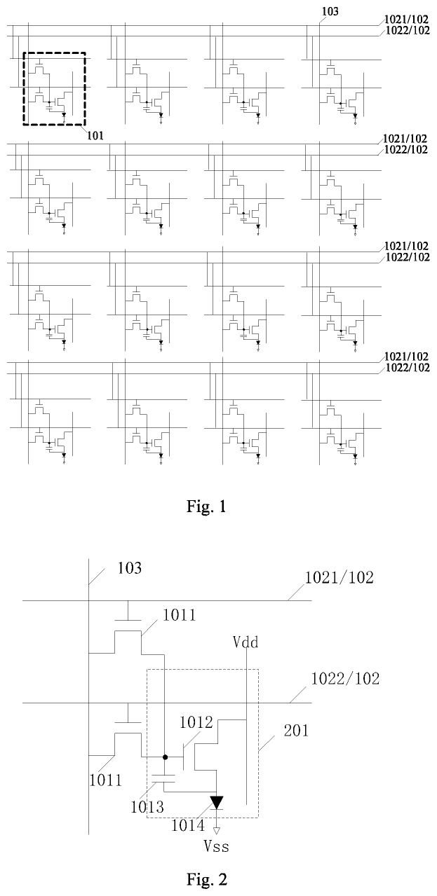

FIG. 1 is a schematic structural diagram of a pixel array according to an embodiment of the present disclosure. As shown in FIG. 1, a pixel array according to an embodiment of the present disclosure includes a plurality of rows of pixel units 101. Each row of pixel units 101 are controlled by a plurality of scan lines 102, and each pixel unit 101 is supplied with a data voltage by a data line 103. In the schematic structural diagram of the pixel array provided by FIG. 1, the specific structure of each pixel unit 101 looks relatively compact. In order to facilitate presenting the specific structure of each pixel unit 101, one pixel unit 101 in the pixel array is individually shown in FIG. 2. FIG. 2 is a schematic structural diagram of a pixel unit according to an embodiment of the present disclosure. The pixel unit 101 includes a plurality of switch transistors 1011 and a display module 201. The number of the plurality of switch transistors 1011 is equal to the number of the plurality of scan lines 102. The plurality of switch transistors 1011 have first electrodes all coupled to the data line 103, second electrodes all coupled to the display module 201, and control electrodes coupled, in one-to-one correspondence, to the plurality of scan lines 102, which control the row of pixel units 101 to which the pixel unit 101 belongs.

It should be noted that the pixel array provided by the embodiments of the present disclosure may have a plurality of rows of pixel units, and a plurality of scan lines 102 may be configured to control each row of pixel units 101. For the convenience of description, as an example, the number of the scan lines 102 which control each row of pixel units 101 is two and the number of the rows of pixel units 101 is four in the present disclosure. Since the number of the scan lines which control each row of pixel units 101 is two, the number of the switch transistors 1011 in each pixel unit 101 is correspondingly two. The two scan lines 102 which control the first row of pixel units 101 are respectively referred to as a first scan line 1021 and a second scan line 1022; correspondingly, the switch transistor 1011 coupled to the first scan line 1021 in each pixel unit 101 is referred to as a first switch transistor, and the switch transistor 1011 coupled to the second scan line 1022 in each pixel unit 101 is referred to as a second switch transistor.

In some embodiments, for the pixel array provided by the embodiments of the present disclosure, high-level signals are simultaneously input to the first scan line 1021 which controls the first row of pixel units 101 and the first scan line 1021 which controls the second row of pixel units 101, so that the first switch transistors in the two rows of pixel units 101 coupled to the first scan lines 1021 are turned on. At this time, data voltage signals are simultaneously input to the data lines 103 which provide data voltages to respective pixel units 101 in the first and second rows, so as to charge the display modules 201 in the first row of pixel units 101 and the second row of pixel units 101, and enable the display modules 201 to perform display under the data voltages input by the data lines 103. In the same way, high-level signals are simultaneously input to the first scan lines 1021 which control the third row of pixel units 101 and the fourth row of pixel units 101, and the display modules 201 in the third row of pixel units 101 and the fourth row of pixel units 101 perform display under the data voltages input by the data lines 103. Then, high-level signals are simultaneously input to the second scan line 1022 which controls the first row of pixel units 101 and the second scan line 1022 which controls the second row of pixel units 101, so that the second switch transistors in the two rows of pixel units 101 coupled to the second scan lines 1022 are turned on. At this time, data voltage signals are simultaneously input to the data lines 103 which provide data voltages to respective pixel units 101 in the first and second rows, so as to charge the display modules 201 in the first row of pixel units 101 and the second row of pixel units 101, and enable the display modules 201 to perform display again under the data voltages input by the data lines 103. In the same way, high-level signals are simultaneously input to the second scan lines 1022 which control the third row of pixel units 101 and the fourth row of pixel units 101, and the display modules 201 in the third row of pixel units 101 and the fourth row of pixel units 101 perform display again under the data voltages input by the data lines 103. Thus, the display and refreshing of an image displayed by the entire pixel array are completed.

In the pixel array provided by the above embodiments of the present disclosure, each row of pixel units 101 can be controlled by two scan lines 102, high-level signals can be simultaneously input to two adjacent rows of pixel units 101, and the two adjacent rows of pixel units 101 can be simultaneously scanned, so that two rows of pixel units 101 can perform display at the same time, thereby achieving the display and refreshing of all the rows of pixel units 101 in the entire pixel array. Compared with the case in the related art where all rows of pixel units 101 are scanned line by line to perform display and refreshing, the present disclosure can at least save half of the time spent in scanning the entire pixel array and thus can increase a refresh rate of the pixel array by times, thereby meeting the requirement of high refresh rate, and improving a display effect.

It could be understood that, in the case where each row of pixel units 101 are controlled by M scan lines and M is an integer greater than 2, high-level signals can be simultaneously input to a plurality of rows of pixel units, and a plurality of adjacent rows of pixel units 101 can be simultaneously scanned to perform display at the same time, thus achieving the display and refreshing of all of the pixel units 101 in the entire pixel array. In this way, more scanning time can be saved, so that the refresh rate of the entire pixel array can be increased to meet the requirement of high-rate refreshing.

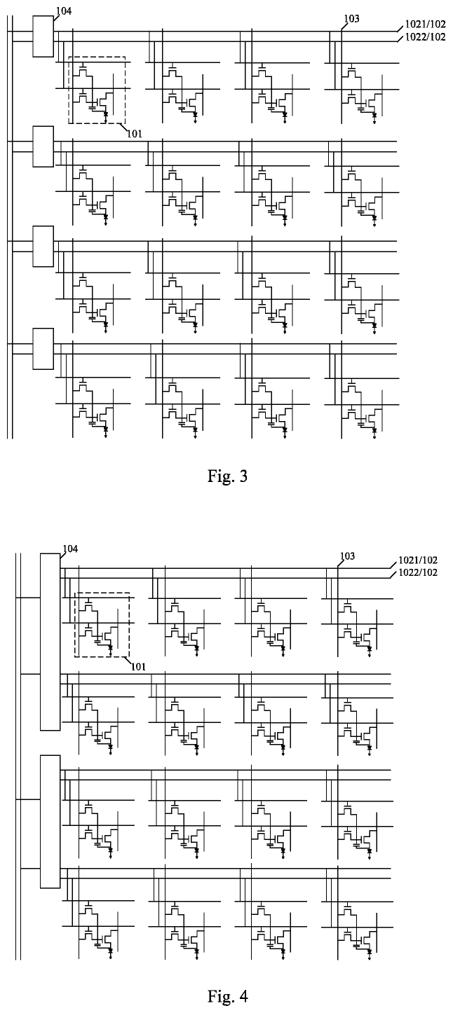

In some embodiments, as shown in FIG. 3, in addition to the plurality of rows of pixel units 101, the pixel array further includes a plurality of gate drive circuits 104. Each gate drive circuit 104 controls one row of pixel units 101, and different rows of pixel units 101 are controlled by different gate drive circuits 104; and signal output terminals of each gate drive circuit 104 are coupled, in one-to-one correspondence, to a plurality of scan lines 102, which are configured to control the row of pixel units 101 corresponding to the gate drive circuit 104.

It should be noted that each gate drive circuit 104 in the pixel array provided by the embodiments of the present disclosure controls one row of pixel units 101, and the signal output terminals of each gate drive circuit 104 are coupled, in one-to-one correspondence, to a plurality of scan lines 102, which control the one row of pixel units 101. In the embodiments of the present disclosure, two scan lines 102 are disposed to control each row of pixel units 101, and are respectively referred to as the first scan line 1021 and the second scan line 1022, and the gate drive circuit 104 are correspondingly provided with two signal output terminals, which are respectively referred to as a first signal output terminal and a second signal output terminal. The first signal output terminal of the gate drive circuit 104 is coupled to the first scan line 1021 which controls the row of pixel units 101, and the second signal output terminal is coupled to the second scan line 1022 which controls the row of pixel units 101. The other gate drive circuits 104 are coupled in the same manner. In the embodiments of the present disclosure, two adjacent gate drive circuits can operate simultaneously, each gate drive circuit 104 can input a high-level signal to the scan line coupled thereto through the corresponding signal output terminal, and two adjacent rows of pixel units 101 can be simultaneously scanned to perform display at the same time, thus achieving the display and refreshing of all the pixel units 101 in the entire pixel array. In this way, the scanning time of the entire pixel array can be shortened, so that the refresh rate can be increased to meet the requirement of high refresh rate.

In some embodiments of the present disclosure, the number of the scan lines 102 which control each row of pixel units 101 is two, the number of the rows of pixel units 101 is four, and in a same column of pixel units pixel units at an interval of N rows are supplied with data voltages by a same data line, with N being an integer greater than or equal to 1. For example, among the pixel units 101 in the same column, the pixel units 101 in every other row may be supplied with the data voltages by the same data line 103. In this case, the pixel units 101 in odd rows are supplied with the data voltages by a same data line 103, and the pixel units 101 in even rows are supplied with the data voltages by a same data line 103, so that two adjacent rows of pixel units 101 can perform display at the same time.

It should be noted that, in the embodiments of the present disclosure, the gate drive circuit 104 which controls the first row of pixel units 101 and the gate drive circuit 104 which controls the second row of pixel units 101 can simultaneously input high-level signals to the corresponding scan lines, so that the first row of pixel units 101 and the second row of pixel units 101 can be simultaneously scanned. When the gate drive circuit which controls the first row of pixel units 101 inputs a high-level signal to the corresponding scan line, the gate drive circuit 104 which controls the third row of pixel units 101 can be controlled not to scan the third row of pixel units 101, which allows the data line not to supply a data voltage to the corresponding pixel unit 101 in the third row. Therefore, among the pixel units 101 in the same column, the pixel units 101 at an interval of one row can be supplied with the data voltages by the same data line 103. The switch transistors 1011 and a driving transistor 1012 in each pixel unit 101 control whether to write a data voltage to a light emitting device 1014, so as to enable each pixel unit 101 to perform display and refreshing. Thus, the number of the data lines 103 can be decreased, thereby reducing wiring difficulty of the data lines 103.

In some embodiments, as shown in FIG. 4, in addition to the plurality of rows of pixel units 101, the pixel array further includes a plurality of gate drive circuits 104, each of which controls a plurality of adjacent rows of pixel units 101; and signal output terminals of each gate drive circuit 104 are coupled, in one-to-one correspondence, to a plurality of scan lines 102, which are configured to control the plurality of rows of pixel units 101 corresponding to the gate drive circuit 104.

It should be noted that each gate drive circuit 104 in the pixel array provided by the embodiments of the present disclosure can control a plurality of adjacent rows of pixel units 101, and the signal output terminals of each gate drive circuit 104 are coupled, in one-to-one correspondence, to a plurality of scan lines 102, which control the plurality of rows of pixel units 101. In an embodiment of the present disclosure, one gate drive circuit 104 can control two rows of pixel units 101, two scan lines 102 are disposed to control each row of pixel units 101, and are respectively referred to as the first scan line 1021 and the second scan line 1022, and the gate drive circuit 104 is correspondingly provided with two signal output terminals, which are respectively referred to as a first signal output terminal and a second signal output terminal. The first signal output terminal of the gate drive circuit 104 is coupled to the first scan line 1021 which controls the first row of pixel units 101 and the first scan line 1021 which controls the second row of pixel units 101, and the second signal output terminal of the gate drive circuit 104 is coupled to the second scan line 1022 which controls the first row of pixel units 101 and the second scan line 1022 which controls the second row of pixel units 101. The other gate drive circuits 104 are coupled in the same manner. In the embodiments of the present disclosure, one gate drive circuit 104 can control a plurality of adjacent rows of pixel units 101, so that the number of the gate drive circuits 104 can be decreased, thereby reducing process difficulty and saving manufacturing cost.

In some embodiments, the pixel units 101 located in the same column and controlled by different gate drive circuits 104 are supplied with data voltages by the same data line 103. It could be understood that the pixel units 101 controlled by the same gate drive circuit 104 are supplied with data voltages by different data lines 103.

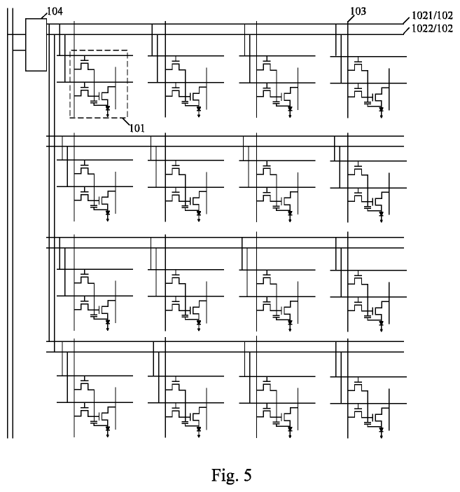

In the embodiments of the present disclosure, the gate drive circuit which controls two adjacent rows of pixel units 101 can simultaneously input a high-level signal to the first scan lines 1021 of the two controlled adjacent rows of pixel units 101 through the first signal output terminal, and then simultaneously input a high-level signal to the second scan lines 1022 of the two adjacent rows of pixel units 101, so that the two adjacent rows of pixel units 101 can be simultaneously scanned. Different gate drive circuits 104 may operate at different time, which allows the pixel units 101 coupled thereto through the corresponding scan lines 102 to operate at different time. The pixel units 101 which are located in the same column but do not operate at the same time may be supplied with data voltages by the same data line 103. The switch transistors 1011 and a driving transistor 1012 in each pixel unit 101 control whether to write a data voltage to a light emitting device 1014 in the pixel unit 101, so as to enable each pixel unit 101 to perform display and refreshing. Thus, the number of the data lines 103 can be decreased, thereby reducing the wiring difficulty of the data lines 103. For example, in the case where each gate drive circuit 104 controls I adjacent rows of pixel units 101, I being an integer greater than or equal to 2 and the plurality of gate drive circuits 104 do not operate at the same time, among the pixel units 101 in the same column, the pixel units 101 at an interval of (I−1) rows may be supplied with data voltages by the same data line. In some embodiments, as shown in FIG. 5, the pixel array includes only one gate drive circuit 104 in addition to the plurality of rows of pixel units 101, and signal output terminals of the gate drive circuit 104 are coupled, in one-to-one correspondence, to the plurality of scan lines 102, which are configured to control each row of pixel units 101.

It should be noted that one gate drive circuit 104 in the pixel array provided by the embodiments of the present disclosure can control all the rows of pixel units 101, and the signal output terminals of the gate drive circuit 104 are coupled, in one-to-one correspondence, to the scan lines 102, which control each row of pixel units 101. In the embodiments of the present disclosure, two scan lines 102 are disposed to control each row of pixel units 101, and are respectively referred to as the first scan line 1021 and the second scan line 1022, and the gate drive circuit 104 are correspondingly provided with two signal output terminals, which are respectively referred to as a first signal output terminal and a second signal output terminal. The first scan lines 1021 which control all the rows of pixel units 101, i.e., four first scan lines 1021, are coupled to one another and then are coupled to the first signal output terminal of the gate drive circuit 104, and the second scan lines 1022 which control all the rows of pixel units 101, i.e., four second scan lines 1022, are coupled to one another and then are coupled to the second signal output terminal of the gate drive circuit 104. The one gate drive circuit 104 can simultaneously input a high-level signal to the first scan lines 1021 which control all the rows of pixel units through the first signal output terminal, and then simultaneously input a high-level signal to the second scan lines 1022 which control all the rows of pixel units through the second signal output terminal, so that all the rows of pixel units in the entire pixel array can be simultaneously scanned, which shortens the scanning time of the entire pixel array and increasing the refresh rate. In the embodiments of the present disclosure, one gate drive circuit 104 can control all the rows of pixel units 101, so that the number of the gate drive circuits 104 can be decreased, thereby reducing the process difficulty and further saving the manufacturing cost.

In some embodiments, the pixel units 101 are disposed in one-to-one correspondence with the data lines 103.

It should be noted that each pixel unit 101 in the pixel array provided by the embodiments of the present disclosure may be supplied with a data voltage by an independent data line 103, so that an independent data voltage can be accurately input to each pixel unit 101, which can avoid mutual influence between the pixel units 101 in the same column. Instead of sequentially writing data voltage signals to the pixel units 101 line by line, the data voltage signals can be written to all the pixel units 101 at the same time, so that the writing time of the data voltage signals is shortened, thereby increasing the refresh rate.

In addition to the plurality of rows of pixel units 101 and the gate drive circuit 104, the pixel array provided by the embodiments of the present disclosure may further include a clock timing controller, a data signal controller and a data timing controller. The clock timing controller is coupled to the gate drive circuit 104 and configured to provide a clock timing signal to the gate drive circuit 104. The data signal controller is coupled to the pixel units 101 and configured to provide data voltages to the pixel units 101. The data timing controller is coupled to the data signal controller and configured to provide a data timing signal to the data signal controller.

It should be noted that the clock timing controller, the data signal controller and the data timing controller may be integrated in the same driving chip, and coupled to the plurality of rows of pixel units 101 and the gate drive circuit 104 in the above coupling manner, and the clock timing controller can control a time sequence in which the gate drive circuit 104 outputs gate drive signals, so as to enable the plurality of scan lines 102 to output different gate drive signals. The data signal controller can provide data voltages to the pixel units to enable all the pixel units 101 to display an image. Meanwhile, the data timing controller can control a time sequence of the data voltages provided by the data signal controller, thereby realizing high-rate display and refreshing of a display panel.

In the embodiments, as shown in FIG. 2, the display module 201 of the pixel unit 101 in the pixel array provided by the embodiments of the present disclosure may include a driving transistor 1012, a storage capacitor 1013 and a light emitting device 1014. The sources of the plurality of switch transistors 1011 in the pixel unit 101 are all coupled to the data line 103, the drains of the plurality of switch transistors 1011 are all coupled to a first terminal of the storage capacitor 1013 and a gate of the driving transistor 1012, and the gates of the plurality of switch transistors 1011 are coupled in one-to-one correspondence to the scan lines 102, which control the row of pixel units 101 to which the pixel unit 101 belongs. The driving transistor 1012 has a source coupled to a first power supply terminal Vdd, a drain coupled to a second terminal of the storage capacitor 1013 and a first electrode of the light emitting device 1014, and the gate coupled to the first terminal of the storage capacitor 1013 and the drain of each switch transistor 1011; the first terminal of the storage capacitor 1013 is coupled to the drain of each switch transistor 1011 and the gate of the driving transistor 1012, and the second terminal of the storage capacitor 1013 is coupled to the drain of the driving transistor 1012 and the first electrode of the light emitting device 1014; and the first electrode of the light emitting device 1014 is coupled to the drain of the driving transistor 1012 and the second terminal of the storage capacitor 1013, and the second electrode of the light emitting device 1014 is coupled to a second power supply terminal Vss.

In an embodiment, for the pixel array provided by the embodiments of the present disclosure, high-level signals are simultaneously input to the first scan line 1021 which controls the first row of pixel units 101 and the first scan line 1021 which controls the second row of pixel units 101, so that the first switch transistors in the two rows of pixel units 101 coupled to the first scan lines 1021 are turned on. At this time, data voltage signals are simultaneously input to the data lines 103 which provide data voltages for pixel units 101 in the first and second rows, so as to charge the storage capacitors 1013 in the first row of pixel units 101 and the second row of pixel units 101, and the driving transistors 1012 are turned on when gate-source voltages Vgs of the driving transistors 1012 are greater than a threshold voltage Vth during the charging, so that the light emitting devices 1014 in the first row of pixel units 101 and the second row of pixel units 101 emit light. In the same way, high-level signals are simultaneously input to the first scan lines 1021 which control the third row of pixel units 101 and the fourth row of pixel units 101, and the light emitting devices in the third row of pixel units 101 and the fourth row of pixel units 101 emit light. Then, high-level signals are simultaneously input to the second scan line 1022 which controls the first row of pixel units 101 and the second scan line 1022 which controls the second row of pixel units 101, so that the second switch transistors in the two rows of pixel units 101 coupled to the second scan lines 1022 are turned on. At this time, data voltage signals are simultaneously input to the data lines 103 which provide data voltages for pixel units 101 in the first and second rows, so as to charge the storage capacitors 1013 in the first row of pixel units 101 and the second row of pixel units 101 again, and the driving transistors 1012 are turned on when the gate-source voltages Vgs of the driving transistors 1012 are greater than the threshold voltage Vth during the charging, so that the light emitting devices 1014 in the first row of pixel units 101 and the second row of pixel units 101 emit light again. In the same way, high-level signals are simultaneously input to the second scan line 1022 which controls the third row of pixel units 101 and the second scan line 1022 which controls the fourth row of pixel units 101, and the light emitting devices in the third row of pixel units 101 and the fourth row of pixel units 101 emit light again. Thus, the display and refreshing of an image by the entire pixel array are completed.

In some embodiments, the pixel unit 101 includes a red sub-pixel unit, a green sub-pixel unit and a blue sub-pixel unit.

It should be noted that the pixel unit 101 may include a red sub-pixel unit, a green sub-pixel unit and a blue sub-pixel unit, or may include a red sub-pixel unit, a green sub-pixel unit, a blue sub-pixel unit and a white sub-pixel unit, or all the sub-pixel units in the pixel unit 101 are white sub-pixel units. By inputting different data voltages to the pixel unit 101, a grey scale value of each sub-pixel unit in the pixel unit 101 can be adjusted, so that the pixel unit 101 can realize multi-color or single-color display and refreshing.

In another aspect, an embodiment of the present disclosure provides an array substrate including the pixel array provided by the above embodiments. The implementation principle of the array substrate is the same as that of the pixel array provided by the above embodiments, and thus is not repeated here.

In still another aspect, an embodiment of the present disclosure provides a display device including the array substrate provided by the above embodiment. The implementation principle of the display device is the same as that of the pixel array provided by the above embodiments, and thus is not repeated here.

The display device may be any product or component with a display function, such as a liquid crystal display (LCD) panel, an organic light-emitting diode (OLED) display panel, electronic paper, a mobile phone, a tablet computer, a television, a monitor, a notebook computer, a digital photo frame and a navigator.

It could be understood that the above embodiments are merely exemplary embodiments employed to illustrate the principle of the present disclosure, and the present disclosure is not limited thereto. Those of ordinary skill in the art can make various changes and improvements without departing from the spirit and essence of the present disclosure, and those changes and modifications should be considered to fall within the protection scope of the present disclosure.

1. A pixel array, comprising a plurality of rows of pixel units; wherein,
each row of pixel units are controlled by a plurality of scan lines, and each pixel unit is supplied with a data voltage by a data line; and
each pixel unit comprises a plurality of switch transistors and a display module; and the plurality of switch transistors have first electrodes all coupled to the data line, second electrodes all coupled to the display module, and control electrodes coupled in one-to-one correspondence to the plurality of scan lines, which control the row of pixel units to which the pixel unit belongs.

2. The pixel array of claim 1, further comprising at least one gate drive circuit, wherein each gate drive circuit controls at least one row of pixel units;
signal output terminals of each gate drive circuit are coupled in one-to-one correspondence to the plurality of scan lines, which are configured to control each row of pixel units controlled by the gate drive circuit.

3. The pixel array of claim 2, wherein a number of the at least one gate drive circuit is plural, each gate drive circuit controls one row of pixel units, and different rows of pixel units are controlled by different gate drive circuits; and
signal output terminals of each gate drive circuit are coupled in one-to-one correspondence to the plurality of scan lines, which are configured to control one row of pixel units controlled by the gate drive circuit.

4. The pixel array of claim 3, wherein among the pixel units in a same column, pixel units at an interval of N rows are supplied with data voltages by a same data line, with N being an integer greater than or equal to 1.

5. The pixel array of claim 2, wherein a number of the at least one gate drive circuit is plural, and every I adjacent rows of pixel units are controlled by one gate drive circuit, with I being an integer greater than or equal to 2; and
signal output terminals of each gate drive circuit are coupled in one-to-one correspondence to the plurality of scan lines, which are configured to control each row of pixel units controlled by the gate drive circuit.

6. The pixel array of claim 5, wherein among pixel units in a same column, pixel units controlled by different gate drive circuits are supplied with data voltages by a same data line.

7. The pixel array of claim 6, wherein different gate drive circuits operate at different time; and among the pixel units in the same column, pixel units at an interval of (I−1) rows are supplied with data voltages by a same data line.

8. The pixel array of claim 2, wherein a number of the at least one gate drive circuit is 1, and the plurality of rows of pixel units are controlled by the one gate drive circuit, and
signal output terminals of the gate drive circuit are coupled in one-to-one correspondence to the plurality of scan lines, which are configured to control each row of pixel units.

9. The pixel array of claim 1, wherein the pixel units are disposed in one-to-one correspondence with the data lines.

10. The pixel array of claim 2, further comprising a clock timing controller; wherein
the clock timing controller is coupled to the gate drive circuit and configured to provide a clock timing signal to the gate drive circuit.

11. The pixel array of claim 10, further comprising a data signal controller and a data timing controller; wherein
the data signal controller is coupled to the pixel unit and configured to provide a data voltage to the pixel unit; and
the data timing controller is coupled to the data signal controller and configured to provide a data timing signal to the data signal controller.

12. The pixel array of claim 1, wherein the display module comprises a driving transistor, a storage capacitor and a light emitting device;
the driving transistor has a first electrode coupled to a first power supply terminal, a second electrode coupled to a second terminal of the storage capacitor and a first electrode of the light emitting device, and a control electrode coupled to a first terminal of the storage capacitor and a second electrode of each switch transistor;
the first terminal of the storage capacitor is coupled to the second electrode of each switch transistor and the control electrode of the driving transistor, and the second terminal of the storage capacitor is coupled to the second electrode of the driving transistor and the first electrode of the light emitting device; and
the first electrode of the light emitting device is coupled to the second electrode of the driving transistor and the second terminal of the storage capacitor, and the second electrode of the light emitting device is coupled to a second power supply terminal.

13. The pixel array of claim 1, wherein the pixel unit comprises a red sub-pixel unit, a green sub-pixel unit and a blue sub-pixel unit.

14. An array substrate, comprising the pixel array of claim 1.

15. A display device, comprising the array substrate of claim 14.
